(19) United States
(12) Patent Application Publication
(10) Pub. No.: US 2008/0065358 A1
(43) Pub. Date: Mar. 13, 2008

(54) Method for optimizing cockpit support structures

(75) Inventors: Dirk Mundinger, Rodgau (DE); Thomas Vorberg, Goldbach (DE)

Correspondence Address: COHEN, PONTANI, LIEBERMAN & PAVANE, 551 FIFTH AVENUE, SUITE 1210, NEW YORK, NY, 10176, US

(73) Assignee: Siemens VDO Automotive AG

(21) Appl. No.: 11/894,988

(22) Filed: Aug. 22, 2007

(30) Foreign Application Priority Data
Aug. 25, 2006 (DE) 10 2006 039 960.9

(51) Int. Cl. G06F 17/50

(52) U.S. Cl. 703/1

(57) ABSTRACT

A method for optimizing a design of a cockpit support structure for motor vehicles for flexible utilization of the available installation space includes initially measuring the maximum installation space available for the support structure and depicting the maximum installation space as a wire-mesh structure. The wire-mesh structure undergoes an iterative optimization process for meeting certain boundary conditions with the aim of volume and weight optimization. Finally, the wire-mesh structure obtained is realized constructively into a component which can be produced by conventional manufacturing method techniques.

### BACKGROUND OF THE INVENTION

1. Field of the Invention

The present invention relates to a method for optimizing the design of a cockpit support structure for motor vehicles, the cockpit support structure being used as a connecting element between the vehicle body and cockpit elements.

2. Description of the Related Art

A support structure used as a connecting element between the vehicle body and cockpit elements in the form of, for example, cockpit transverse members in vehicles, have hitherto been realized or produced constructively in the conventional manner and subsequently checked for static and dynamic load cases by simulation and/or testing. A problem with this construction method is that if the demands are not met, then a re-construction or new construction may be necessary, which can greatly disrupt development processes, in particular if the defect has been recognized only at a very late time in the project.

It is also already known from the automotive field to calculate and optimize support structures using finite element methods. This is conventionally carried out in such a way that a starting model which is based on already-gained constructive experience is depicted as a wire-mesh structure which undergoes an iterative optimization process. A problem in the region of vehicle cockpits is that, during the course of the iteration, problems can occur with the extremely jagged installation space in the region between the vehicle body and cockpit elements. When an interference problem arises between the support structure model and the installation space, it is difficult to alter the installation space and may be virtually impossible especially in late project phases.

### SUMMARY OF THE INVENTION

An object of the present invention to provide a method for optimizing a cockpit support structure, especially for the application of the cockpit support structure in a jagged installation space.

According to an embodiment of the invention, the object is met by a method for optimizing a cockpit support structure for motor vehicles, the cockpit support structure being a connecting element between a vehicle body and cockpit elements, which includes the steps of measuring a maximum installation space available for the support structure, depicting the maximum installation space as a wire-mesh structure, performing an iterative optimization process to obtain a final wire-mesh structure which meets predefined boundary conditions to optimize volume and weight, and producing, from the final wire-mesh structure, a component producible by conventional manufacturing techniques.

It has surprisingly been shown that, with the use of a wire-mesh structure as a starting structure which substantially corresponds to the maximum available installation space, it is possible to very effectively develop optimized components in the region of vehicle cockpits. On the one hand, the installation space limits are clearly defined in the optimization processes and, on the other hand, space sections for the construction can be utilized which have hitherto not been incorporated in the design of the support structure.

The method according to the present invention, allows construction of weight-optimized and volume-optimized cockpit support structures which nevertheless fulfill all of the load demands.

To adhere to the load demands during the optimization process, the boundary conditions used in the step of performing the iterative optimization process include the static and/or dynamic loadings of the structure.

Furthermore, the points of application of dynamic and/or static loads may also be predefined as boundary conditions, wherein this in turn can be carried out with the knowledge of the available installation space.

In a further embodiment, a certain predefined weight parameter preferably serves as a value for ending an iterative optimization process which is unlimited in terms of the number of steps, with the volume of the wire-mesh structure then being directly proportional to the weight if the support structure is to be composed of only a single material. It has also been proven that, for example in the constructive realization of the volume model into a cast part, rib structures may be incorporated in the design to obtain a further considerable weight reduction in relation to a volume body generated using the optimization process.

To prevent any unnecessary use of computing power for the iterative optimization process, the starting wire-mesh structure which illustrates the installation space is a coarse meshwork which is refined toward the end of the optimization process. The detailed design of the wire-mesh structure for the constructive realization is ultimately required only toward the end of the optimization process. The use of a coarse meshwork for the starting structure allows a fast approximation to the end state to be obtained. In addition, the expenditure for generating the starting structure can be reduced by use of the coarse meshwork.

As already discussed, the wire-mesh structure obtained by the optimization process can be incorporated for the realization or production of the support structure as a cast part. The realization or production may take place in a computer-aided manner, wherein it is for example possible for the demolding direction of the cast part to be incorporated as a boundary condition already in the optimization process.

It is however fundamentally also possible for the cockpit support structure to be produced as a sheet metal or welded construction if the support structure is made of a metal material. A use of plastic for the cockpit support structure is of course directly possible if the load demands are of relatively low significance. Hybrid constructions are also possible such as, for example, plastic elements which are injection-molded onto a metal structure.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, in which like reference characters denote similar elements throughout the several views:

FIG. 1 is a perspective view of an available installation space;

FIGS. 2A, 2A1 and 2A2 are perspective views of a wire-mesh structure for depicting the installation space of FIG. 1 in an overall illustration, an enlarged illustration of the left-hand region in connection with the central region and an enlarged illustration of the right-hand region in connection with the central region, respectively;

FIGS. 2B, 2B1 and 2B2 are perspective views of a wire-mesh structure as an intermediate result of an iterative optimization process performed on the wire-mesh structure of FIG. 2A in an overall illustration, an enlarged illustration of the left-hand region in connection with the central region and an enlarged illustration of the right-hand region in connection with the central region, respectively;

FIGS. 2C, 2C1 and 2C2 are perspective views of a wire-mesh structure as a further intermediate result of an iterative optimization process performed on the wire-mesh structure of FIG. 2B in an overall illustration, an enlarged illustration of the left-hand region in connection with the central region and an enlarged illustration of the right-hand region in connection with the central region, respectively;

FIGS. 2D, 2D1 and 2D2 are perspective rear views of a wire-mesh structure as a yet further intermediate result of an iterative optimization process performed on the wire-mesh structure of FIG. 2C in an overall illustration, an enlarged illustration of the left-hand region in connection with the central region and an enlarged illustration of the right-hand region in connection with the central region, respectively;

FIG. 2E is a perspective rear view of a wire-mesh structure as a further intermediate result of the iterative optimization process performed on the wire-mesh structure of FIG. 2D;

FIG. 2F is a perspective rear view of a wire-mesh structure as a further intermediate result of the iterative optimization process performed on the wire-mesh structure of FIG. 2E;

FIG. 2G is a perspective view of an optimized wire-mesh structure from the wire-mesh structure of FIG. 2F; and

FIG. 3 is a perspective view of a cockpit support structure.

### DETAILED DESCRIPTION OF THE PRESENTLY PREFERRED EMBODIMENTS

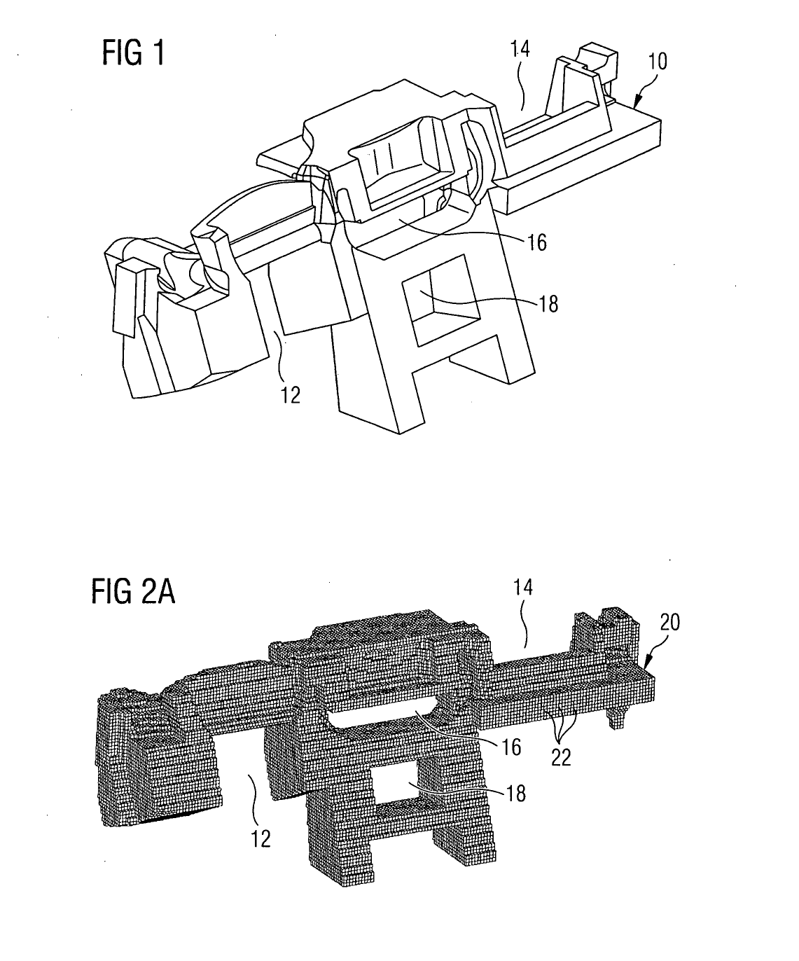

FIG. 1 shows a perspective view of an installation space 10 as is generated in the region of a vehicle cockpit between a bulkhead, which separates an engine bay of a vehicle from a passenger compartment, and cockpit modules which form the visible surfaces and contain the functional elements of the vehicle cockpit, such as for example air conditioning system, audio system, glove compartment, ashtray, instrument cluster and the like. In addition, installation space must also be kept free for further vehicle components such as for example the airbag and the steering column. Arranged in the installation space 10 is a cockpit support structure which must connect the various cockpit modules to the vehicle body in a supporting manner. The cockpit support structure often also performs a load-bearing function for the vehicle body, and in particular in the case of a side impact, the cockpit support structure must also absorb considerable forces and stabilize the passenger compartment. With regard in particular to these load demands, installation space restrictions represent difficult obstacles. For example, provision must be made for a cutout 12 for the steering column, an airbag cutout 14, a passage opening 16 for ventilation ducts and for inserting the air-conditioning unit and a holding opening 18 for other components such as for example the audio system or the navigation unit.

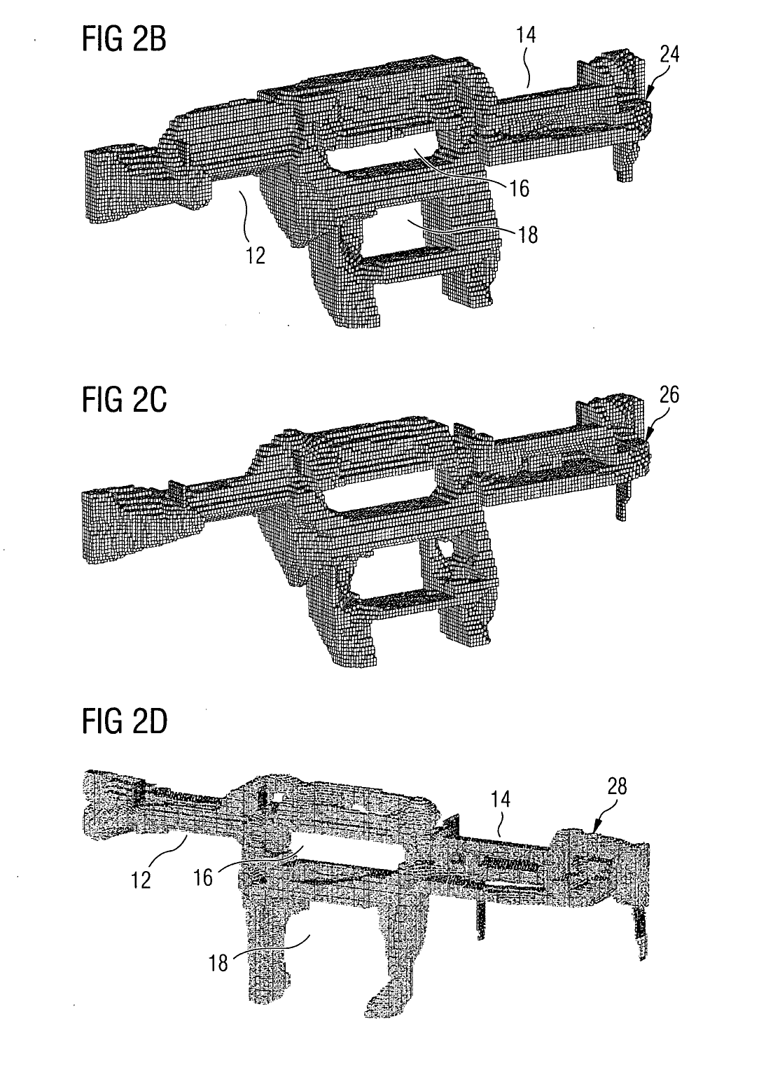

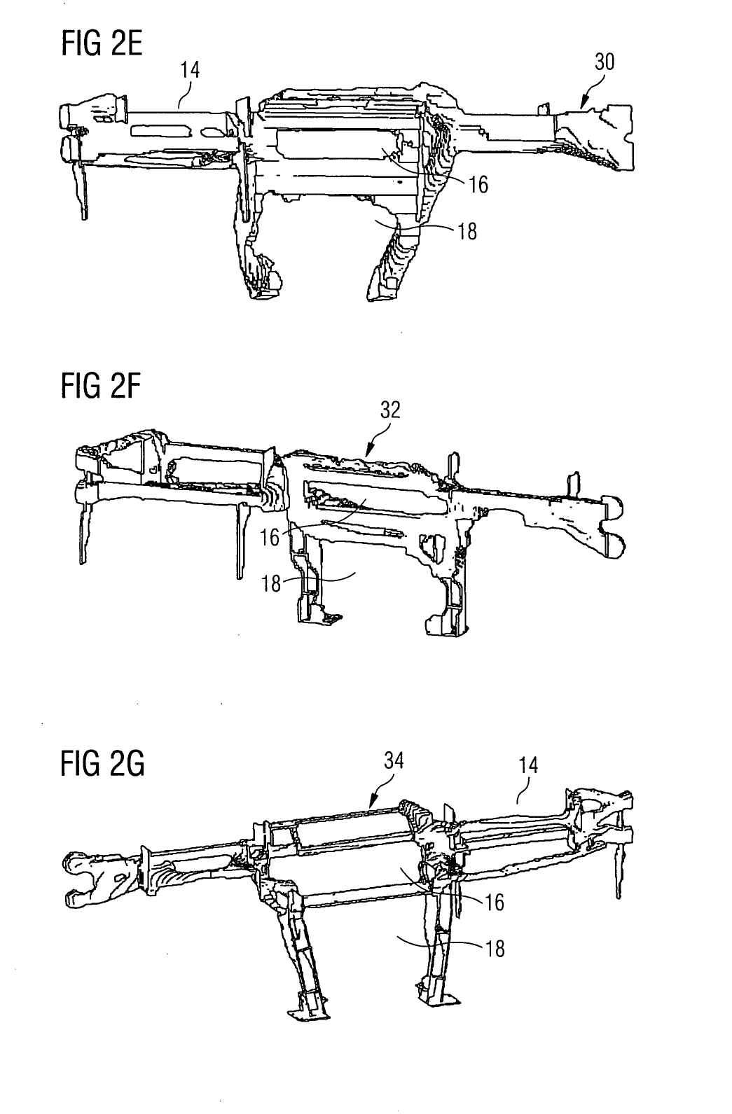

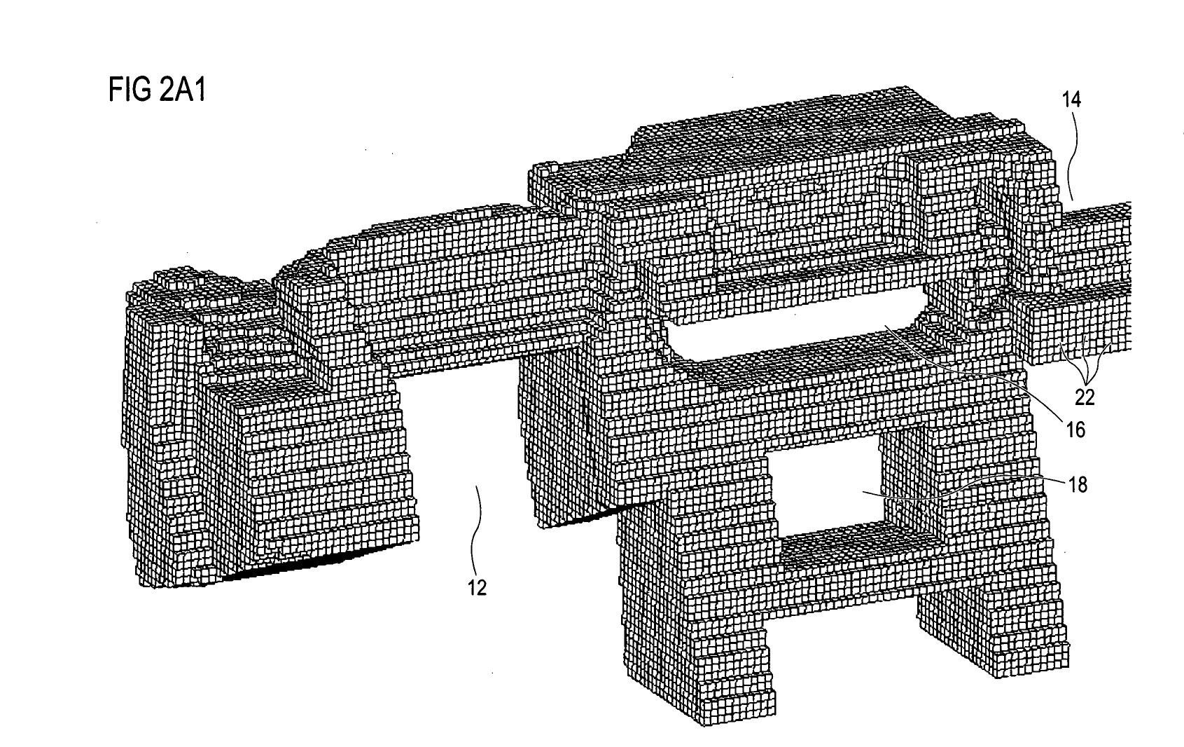

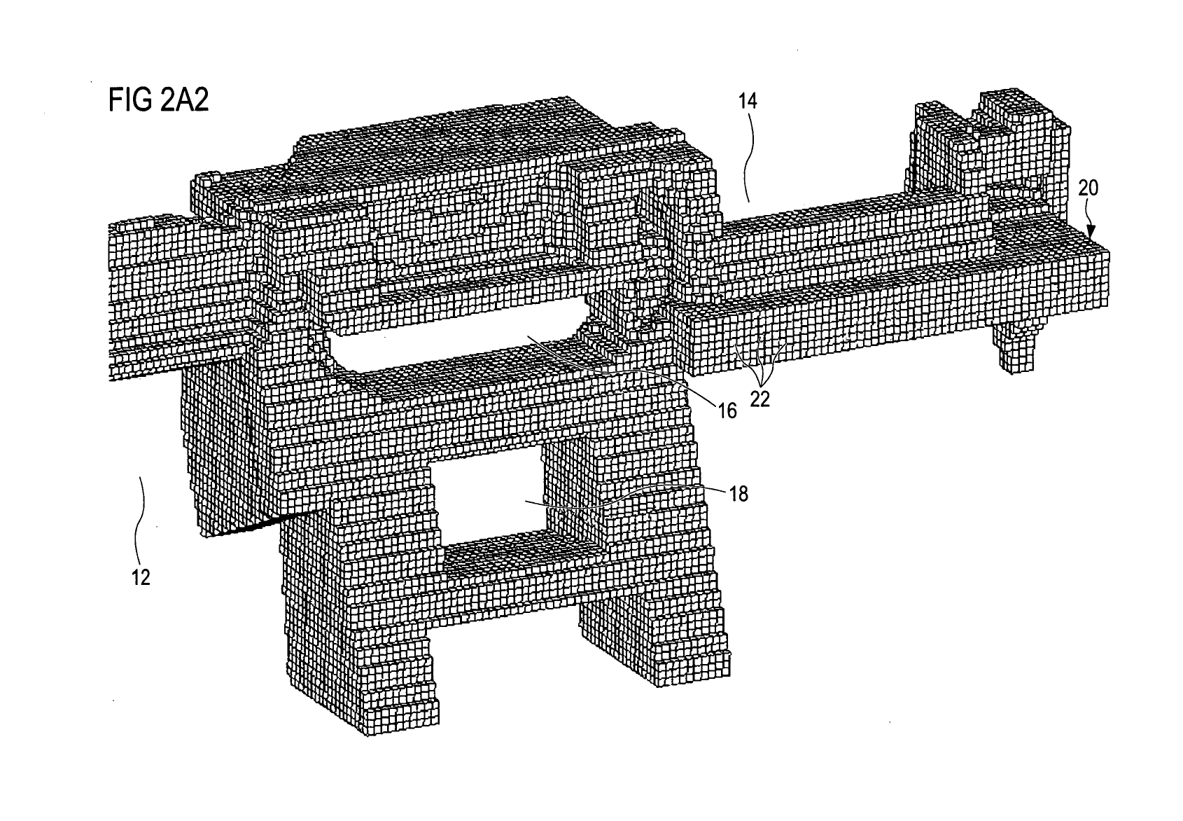

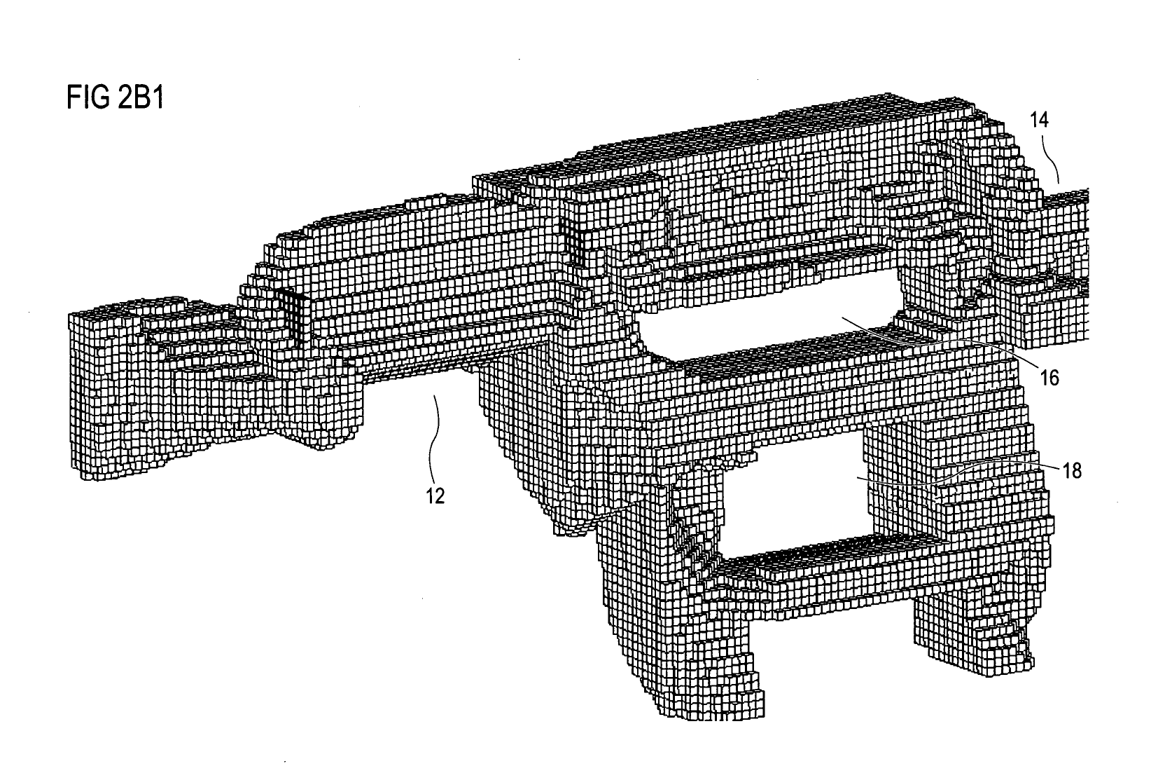

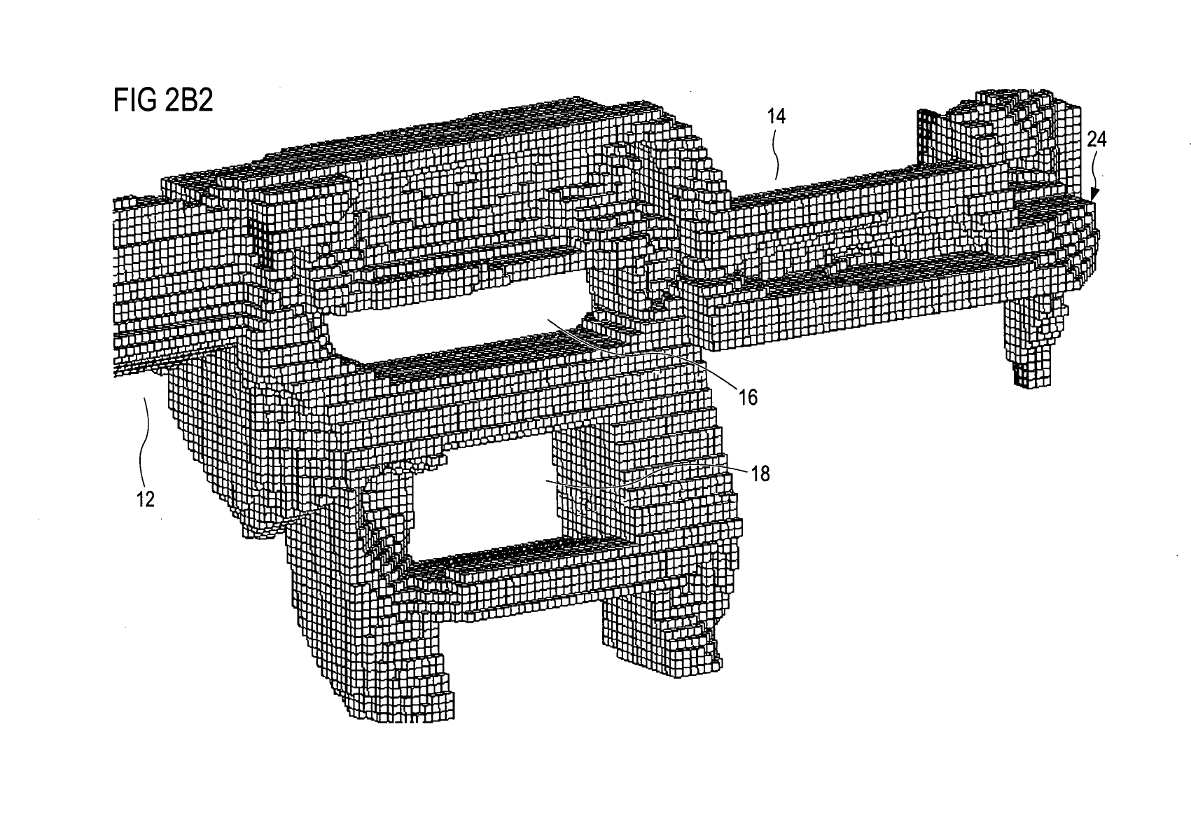

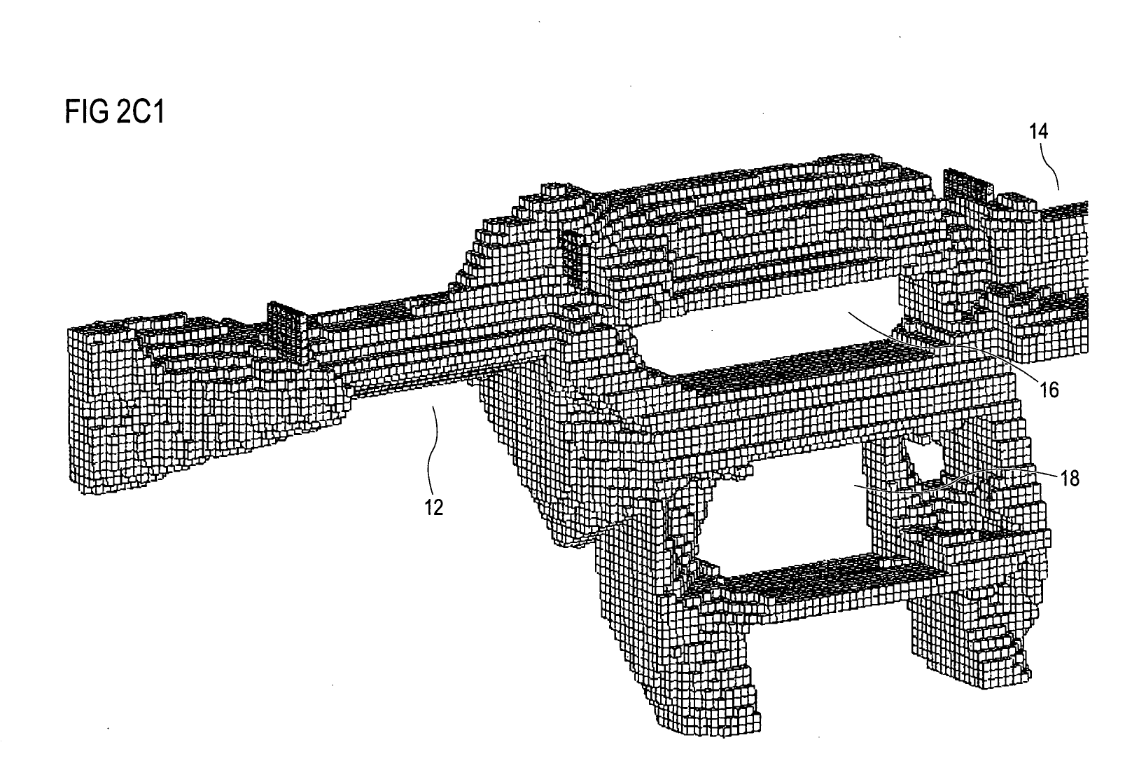

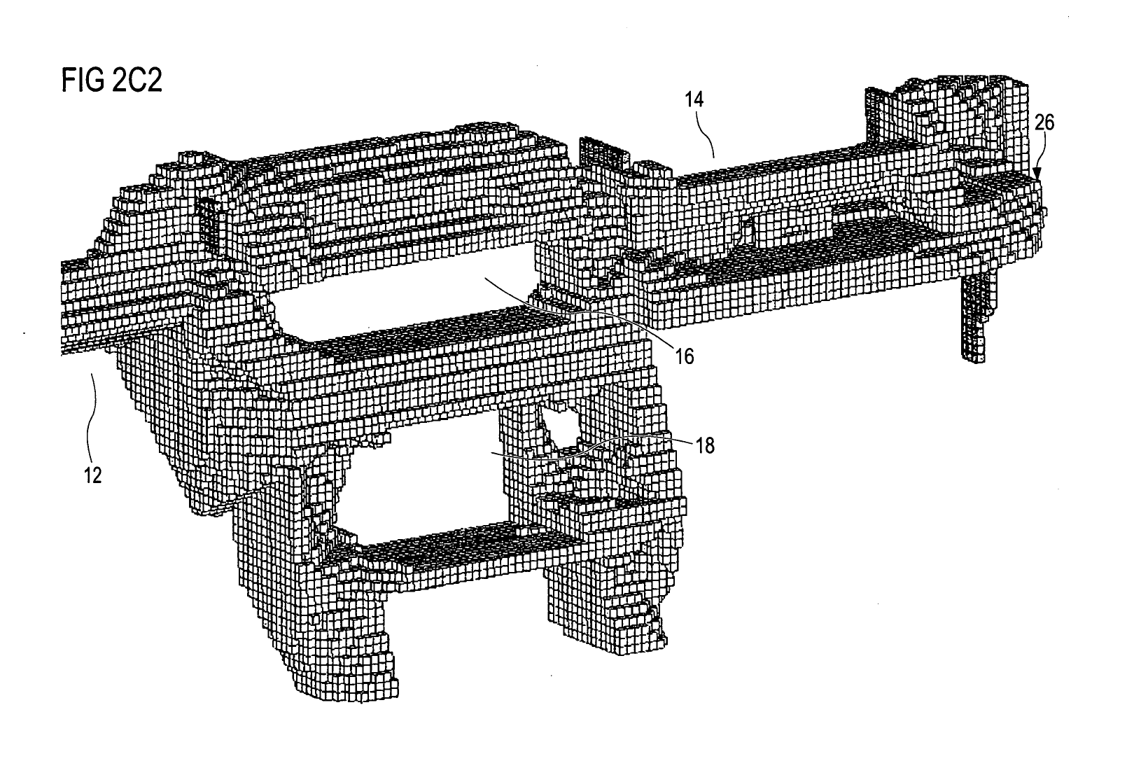

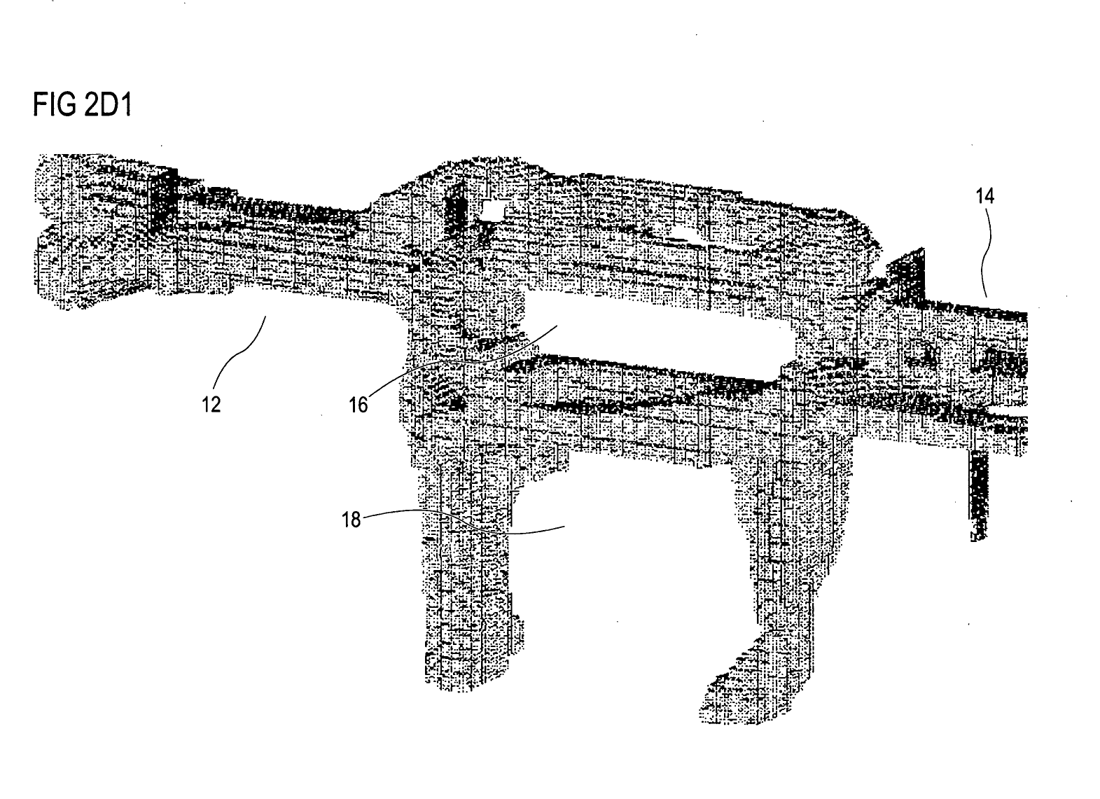

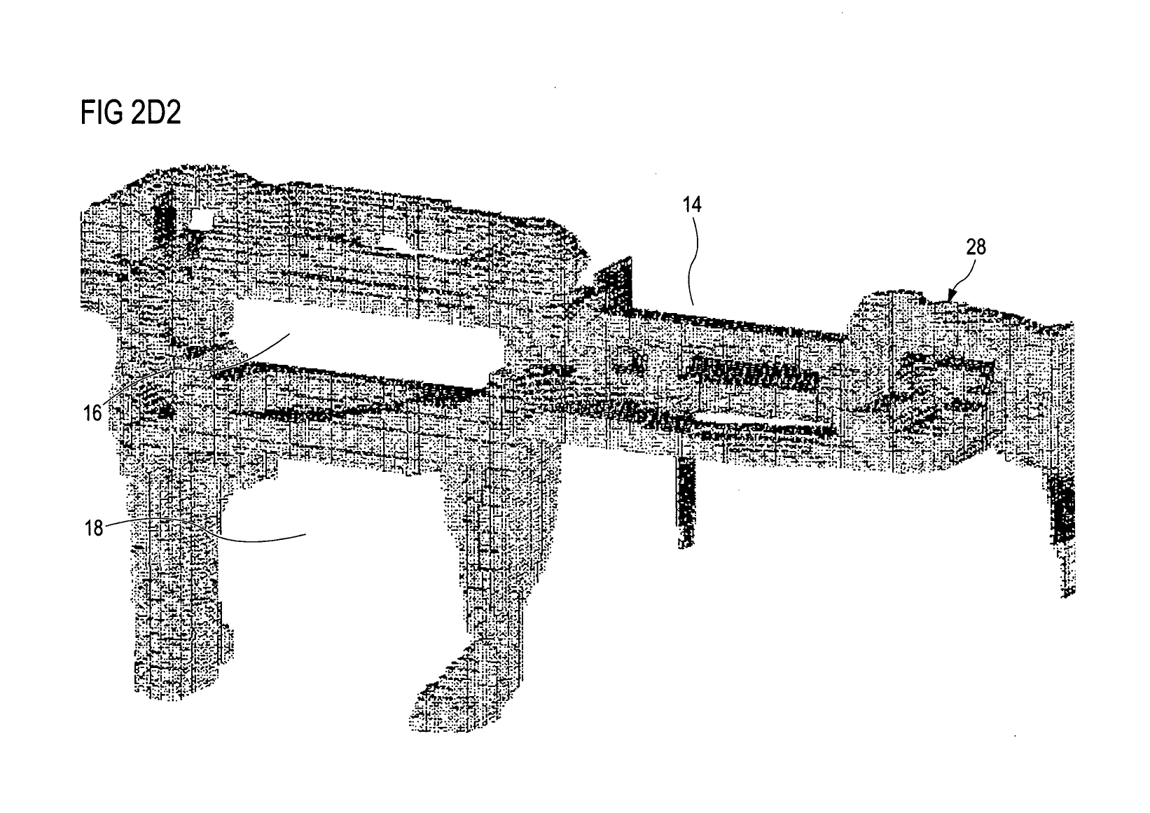

To prevent a conflict with said installation space restrictions from the outset, which conflict can be eliminated in later project phases only with a great degree of expenditure, the installation space 10 shown in FIG. 1 is incorporated for generating a starting wire-mesh structure 20, as is shown in FIGS. 2A, 2A1, and 2A2. FIG. 2A shows the wire-mesh structure in an overall illustration. FIG. 2A1 and FIG. 2A2 respectively show an enlarged illustration of the left-hand region in connection with the central region and an enlarged illustration of the right-hand region in connection with the central region.

This starting wire-mesh structure 20 corresponds substantially to the installation space 10 shown in FIG. 1, wherein a certain degree of abstraction is however accepted on account of the mesh structure which has been selected to be relatively coarse, as can be seen by the grid pattern 22.

If the wire-mesh structure shown in FIGS. 2A, 2A1, and 2A2 were filled with a light metal alloy, as can be used for example in the case of cockpit transverse members as a typical cockpit support structure, the volume would correspond to a weight of 65.5 kg.

FIGS. 2B, 2C and 2D are also shown, in the manner of illustration of FIG. 2A, in each case in an overall illustration (2B, 2C and 2D), an enlarged illustration of the left-hand region in connection with the central region (2B1, 2C1 and 2D1) and an enlarged illustration of the right-hand region in connection with the central region (2B2, 2C2 and 2D2).

FIGS. 2B and 2C and also FIGS. 2B1/2B2 and FIGS. 2C1/2C2 show the results of two successive steps of an iterative optimization process which has the aim of optimizing the starting structure 20 shown in FIGS. 2A, 2A1, and 2A2 with regard to its volume and therefore also its weight. Here, FIGS. 2B, 2B1, and 2B2 show a wire-mesh structure 24 which would correspond to a weight of 45.5 kg if filled with a light metal alloy, while FIGS. 2C, 2C1, and 2C2 show a further optimized wire-mesh structure 26 with a weight equivalent of 35.6 kg if filled with the light metal alloy. The resolution of the mesh structure corresponds to the grid 22 of the starting model 20 shown in FIGS. 2A, 2A1, and 2A2.

The support structure 28 shown in FIGS. 2D, 2D1, and 2D2, has a refined mesh structure, as can be clearly seen on the smaller grid, which is shown for reproduction-related reasons as a pixel structure.

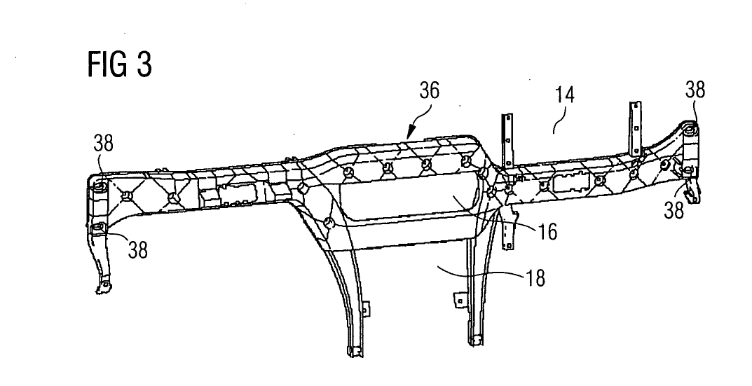

A mesh structure which is further refined in subsequent steps leads, in connection with further optimization steps, to the wire-mesh structure 30 in FIG. 2E with a weight equivalent of 20.3 kg if filled with the light metal alloy, the wire-mesh structure 32 shown in FIG. 2F with a weight equivalent of 11 kg if filled with the light metal alloy and, as a termination of the iterative optimization process, the wire-mesh structure 34 FIG. 2G, whose volume corresponds to a weight of only 5 kg when using a light metal alloy as a material. In FIGS. 2E to 2G, the wire-mesh structures 30, 32, 34 are shown, for better understanding, as a layered model, since in a printed-out illustration of the wire-mesh structure, the lines can coincide even in an enlarged view. The wire-mesh structure 34 illustrated in FIG. 2G is, as an end structure, realized in a cockpit transverse member 36 shown in FIG. 3. In the exemplary embodiment shown, the cockpit transverse member 36 is produced from cast magnesium, with the component shown in FIG. 3 having a weight of 2.7 kg. The demolding direction of a cast component of the cockpit transverse member can additionally also be incorporated already in the optimization process so that no mesh structures are formed there which subsequently cannot be realized into a cast part or can only be realized into a cast part with difficulty.

The cockpit transverse member 36 shown in FIG. 3 has fastening bores 38, by means of which it can be screwed to the bodyshell of a vehicle. The cutouts shown in FIG. 1 are kept free so that the cockpit modules, which under some circumstances have been designed already before the constructive realization of the cockpit transverse member 36, can be fixed to the transverse member 36 without problems.

While a transverse member which is composed of a magnesium alloy is shown in FIG. 3, it is also possible to design the result of the optimization process as a sheet metal and/or welded construction, with it being possible for any peculiarities to also be incorporated already as boundary conditions in the course of the optimization process, similarly to the demolding direction in the case of a cast part. The described method can also be used for cockpit support structures made from plastic, with a correspondingly greater volume of the optimized wire-mesh structure being generated for the same load demands, and hybrid constructions also being possible.

If it is proven that, for defined boundary conditions, it is no longer possible to obtain a realizable wire-mesh structure using the optimization process, the boundary conditions can be weighted in terms of their priority, or individual boundary conditions can be reduced in terms of their demands in a stepped fashion. Boundary conditions which may be used in the optimization process include, for example, the target weight, the material, the static and/or dynamic load demands or else certain points of load application at which there is constructive tolerance. The above list of boundary conditions are examples only and is not to be considered exhaustive.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for optimizing a cockpit support structure for motor vehicles, the cockpit support structure being a connecting element between a vehicle body and cockpit elements, the method comprising the steps of:
measuring a maximum installation space available for the support structure;
depicting the maximum installation space as a wire-mesh structure;
performing an iterative optimization process to obtain a final wire-mesh structure which meets predefined boundary conditions to optimize at least volume and weight of the support structure; and
realizing or producing, from the final wire-mesh structure, a component producible by conventional manufacturing techniques.

2. The method of claim 1, wherein the boundary condition include at least one of static or dynamic loadings to be supported by the cockpit support structure.

3. The method of claim 1, wherein the boundary conditions include points of application of dynamic or static loads to be supported by the cockpit support structure.

4. The method of claim 1, wherein said step of performing the iterative optimization process is ended when a predefined weight parameter is reached.

5. The method of claim 1, wherein said step of depicting includes depicting a starting wire-mesh structure which illustrates the installation space as a coarse meshwork and said step of performing the iterative optimization process includes iteratively refining the coarse meshwork.

6. The method of claim 1, wherein said step of realizing or producing includes producing the cockpit support structure as a cast part.

7. The method of claim 6, wherein a demolding direction of the cast part is incorporated as a boundary condition.

8. The method of claim 1, wherein said step of realizing or producing comprises producing the cockpit support structure from metal.

9. The method of claim 8, wherein said step of realizing or producing comprises producing the cockpit support structure as a sheet metal or welded construction.

10. The method of claim 1, wherein said step of realizing or producing comprises producing the cockpit support structure as a plastic part or as a hybrid component made from metal and plastic.

11. The method of claim 1, wherein said step of realizing or producing comprises realizing the cockpit support structure using a computer-aided design.
